(19) United States
(12) Patent Application Publication
(10) Pub. No.: US 2026/0099324 A1
(43) Pub. Date: Apr. 9, 2026

(54) SYSTEMS AND METHODS FOR EFFICIENT MANAGEMENT OF MERGE FAILURES

(71) Applicant: Blue Origin, LLC, Kent, WA (US)

(72) Inventors: Matthew Rehberg, Kent, WA (US); James Bozsa, Kent, WA (US)

(21) Appl. No.: 18/907,347

(22) Filed: Oct. 4, 2024

(51) Int. Cl. G06F 8/71

(52) U.S. Cl. CPC G06F 8/71

(57) ABSTRACT

An improved system and method that conditionally retry a failed job or remove a merge request that includes the failed job according to whether the failed job meets a condition is described herein. The system is configured to receive a first merge request to merge a first version of source code and a second version of source; receive a second merge request to merge the first version, the second version, and a third version of source code; cause execution of a first plurality of jobs and a second plurality of jobs; identify a failure of a first job; cause execution of individual jobs in the first plurality of jobs and the second plurality of jobs to pause; process failure information associated with the first job failing; compare the failure information with a string associated with a condition to determine whether the failure information satisfies the condition.

### BACKGROUND

Computing devices can utilize communication networks to perform continuous integration and continuous deployment of software projects. The capabilities to allow such continuous integration and continuous deployment allow engineers to concurrently update a main branch of a software project without breaking the main branch. The engineers may each push updates by requesting a merge of the updates with the main branch. To avoid breaking the main branch, processes exist to test the updates against copies of the main branch to ensure integrating the updates maintain operability.

### SUMMARY

The systems, methods, and devices described herein each have several aspects, no single one of which is solely responsible for its desirable attributes. Without limiting the scope of this disclosure, several non-limiting features will now be discussed briefly.

One aspect of the disclosure provides a system comprising a memory comprising computer-executable instructions. The system further comprises a processor, where the computer-executable instructions, when executed by the processor, cause the processor to: receive a first merge request to merge a first version of source code and a second version of source, where the first merge request comprises a first plurality of jobs; receive a second merge request to merge the first version, the second version, and a third version of source code, where the second merge request comprises a second plurality of jobs; cause execution of the first plurality of jobs and the second plurality of jobs; identify a failure of a first job in the first plurality of jobs, where the first job failing provides failure information; cause execution of individual jobs in the first plurality of jobs and the second plurality of jobs to pause; process the failure information associated with the first job failing; compare log data from the failure information with a string associated with a condition to determine whether the failure information satisfies the condition; in response to a determination that the failure information satisfies the condition, retry the failed first job; and in response to a determination that the failure information does not satisfy the condition, pause execution of the first plurality of jobs and the second plurality of jobs that have yet to be executed, update the second merge request to include a merge of the first version of the source code, the third version of the source code, and not the second version of the source code, where the updated second merge request comprises a third plurality of jobs, cause execution of the third plurality of jobs, and remove the first merge request from a list of merge requests to be executed.

The system of the preceding paragraph can include any sub-combination of the following features: where the computer-executable instructions, when executed by the processor, further cause the processor to retry the failed job when the log data includes one or more of: a docker error, a connection error, a virtual central processing unit error, volume limit error, insufficient free address error, segmentation error, library error, license error, and a duration error; where the condition is met when at least a part of the log data matches the string; where the computer-executable instructions, when executed by the processor, further cause the processor to cause the execution of the updated second plurality of jobs prior to completion of the plurality of merge requests; where the computer-executable instructions, when executed by the processor, further cause the processor to update the second plurality of jobs from executing individual jobs corresponding to the first, second, and third versions of the source code to execute individual jobs corresponding to the first version of the source code and the third version of the source code.

Another aspect of the disclosure provides a computer implemented method, under control of a user device with a processor and memory, when executed by the processor, cause the user device to perform steps of: receiving a first merge request to merge a first version of source code and a second version of source, where the first merge request comprises a first plurality of jobs; receiving a second merge request to merge the first version, the second version, and a third version of source code, where the second merge request comprises a second plurality of jobs; causing execution of the first plurality of jobs and the second plurality of jobs; identifying a failure of a first job in the first plurality of jobs, where the first job failing provides failure information; causing execution of individual jobs in the first plurality of jobs and the second plurality of jobs to pause; processing the failure information associated with the first job failing; comparing log data from the failure information with a string associated with a condition to determine whether the failure information satisfies the condition; and in response to a determination that the failure information does not satisfy the condition, pause execution of the first plurality of jobs and the second plurality of jobs that have yet to be executed, update the second merge request to include a merge of the first version of the source code, the third version of the source code, and not the second version of the source code, where the updated second merge request comprises a third plurality of jobs, cause execution of the third plurality of jobs, and remove the first merge request from a list of merge requests to be executed.

The computer implemented method of the preceding paragraph can include any sub-combination of the following features: where the condition is not satisfied when at least a part of the log data matches the string, and where removing the first merge from the list of merge requests comprises removing the first merge when the log data does not include: a docker error, a connection error, a virtual central processing unit error, volume limit error, insufficient free address error, segmentation error, library error, license error, or a duration error; where causing the execution of the third plurality of jobs comprises causing the execution of the third plurality of jobs prior to completion of the plurality of merge requests; where at least one of the first version of source code, the second version of source code, and the third version of source code are directed to design simulation source code; where the first plurality of jobs is associated with merging the first version of source code and the second version of source code, and where the second plurality of jobs is associated with merging the first version of source code, the second version of source code, and the third version of source code; where removing the first merge request from the list of merge requests to be executed comprises: removing the first merge request from the list of merge requests when the first merge request is at a beginning of the list of merge requests; and removing the first merge request from the list of merge requests when a preceding merge request of the plurality of merge requests passed all of a plurality of jobs; where the condition is satisfied when at least a part of the log data matches the string, and where the method further comprises, in response to a determination that the failure information does satisfy the condition, retrying the failed first job; where retrying the failed first job comprises retrying the failed first job when the log data includes one or more of: a docker error, a connection error, a virtual central processing unit error, volume limit error, insufficient free address error, segmentation error, library error, license error, and a duration error; where retrying the failed first job comprises retrying the failed first job by maintaining execution order of the first version of source code, the second version of source code, and the third version of source code.

Another aspect of the disclosure provides a non-transitory, computer-readable storage media comprising computer executable instructions for managing a merge request queue in a merge train, where the computer-executable instructions, when executed by a computer system, cause the computer system to: receive a first merge request to merge a first version of source code and a second version of source, where the first merge request comprises a first plurality of jobs; receive a second merge request to merge the first version, the second version, and a third version of source code, where the second merge request comprises a second plurality of jobs; cause execution of the first plurality of jobs and the second plurality of jobs; identify a failure of a first job in the first plurality of jobs, where the first job failing provides failure information; cause execution of individual jobs in the first plurality of jobs and the second plurality of jobs to pause; process the failure information associated with the first job failing; compare log data from the failure information with a string associated with a condition to determine whether the failure information satisfies the condition; and in response to a determination that the failure information does not satisfy the condition, pause execution of the first plurality of jobs and the second plurality of jobs that have yet to be executed, update the second merge request to include a merge of the first version of the source code, the third version of the source code, and not the second version of the source code, where the updated second merge request comprises a third plurality of jobs, cause execution of the third plurality of jobs, and remove the first merge request from a list of merge requests to be executed.

The non-transitory, computer-readable storage media of the preceding paragraph can include any sub-combination of the following features: where the condition is not satisfied when at least a part of the log data matches the string, and where the computer-executable instructions further cause the computer system to: remove the first merge when the log data does not include: a docker error, a connection error, a virtual central processing unit error, volume limit error, insufficient free address error, segmentation error, library error, license error, or a duration error; remove the first merge request from the list of merge requests when the first merge request is at a beginning of the list of merge requests; and remove the first merge request from the list of merge requests when a preceding merge request of the plurality of merge requests passed all of a plurality of jobs; where the computer-executable instructions further cause the computer system to cause the execution of the third plurality of jobs prior to completion of the plurality of merge requests; where the condition is satisfied when at least a part of the log data matches the string, and where the computer-executable instructions further cause the computer system to, in response to a determination that the failure information does satisfy the condition, retry the failed first job; where the computer-executable instructions further cause the computer system to retry the failed first job when the log data includes one or more of: a docker error, a connection error, a virtual central processing unit error, volume limit error, insufficient free address error, segmentation error, library error, license error, and a duration error; where the computer-executable instructions further cause the computer system to retry the failed first job by maintaining execution order of the first version of source code, the second version of source code, and the third version of source code.

### BRIEF DESCRIPTION OF DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any particular element or act, the most significant digit(s) in a reference number typically refers to the figure number in which that element is first introduced.

FIGS. 1A, 1B, 1C illustrate example continuous integration and continuous deployment environments integrating design simulations in accordance with the disclosure herein.

FIG. 2 illustrates an example development environment with an integration and deployment system in accordance with the disclosure herein.

FIG. 3 illustrates example data flow interactions depicting merge integration and deployment as described in examples herein.

FIG. 4 illustrates an example routine for managing merge requests in accordance with the disclosure herein.

FIG. 5 illustrates a block diagram of an illustrative computing system configured to manage merge requests according to some embodiments.

### DETAILED DESCRIPTION OF SPECIFIC EMBODIMENTS

The present disclosure relates to efficient use of computational resources (e.g., processing power, memory usage, network bandwidth usage, etc.) by conditionally retrying a failed job or removing a merge request that includes the failed job from a merge train according to whether the failed job meets a condition. Advantageously, retrying a failed job or removing a merge request that includes the failed job (for example, comparison of failure information with strings of log data to determine whether to retry the job or remove the merge request) allows for more efficient overall utilization of the computational resources than conventional merge methods. More efficient overall utilization can be especially impactful with computing resources used to innovate or provide other high value services (e.g., updating and simulating spacecraft components without having to restart an entire merge train).

In some approaches, software engineers concurrently work to develop software and merge updates to versions of source code (such as software changes) along a main branch using a technique called a merge train. A merge train creates a queue of various merge requests to a main branch and sequentially tests each merge request for success or failure. The merge train tests each merge request along with code from preceding merge requests, which allows the merge train to test the merge requests in parallel (for example, for merge requests 1-3; merge 1 is tested, merge 1 and 2 are tested together, merge 1, 2, 3 are tested together). The merge train establishes a set of jobs (which may also be referred to herein as “builds” or “tests”) for each of the merge requests to perform and assess whether the merge request succeeds or fails. In this way, the merge train ensures the main branch remains operational before allowing any updates. However, when a merge request includes a failed job in a conventional merge train, the merge train removes the merge request that includes the failed job without determining whether to retry the failed job. Completing the remaining queued merge requests may waste computational resources by restricting resources from being used for other productive tasks.

Not only do conventional merge trains waste computational resources by restricting resource usage when a merge request fails, conventional merge trains may also be impractical when the merge requests include design simulations. For example, as discussed above, when a merge request fails, the conventional merge train still runs the queued merge requests to completion and removes the merge request that includes the failed job from the merge train after the merge request is completed. In this manner, design simulations generally require substantial amounts of time and significant computational resources to simulate the complexities of the hardware systems. The substantial computational resources also apply when performing merge requests to the main branch. In some approaches, removing the failed design simulation may cause the conventional merge train process to last for hours after it is known that the resulting work product is unusable without the removed merge request, restricting computational resources from being used for other merge requests. In this way, the conventional merge train may waste computational resources by continuing to execute merge requests even when it is known that the design simulation has failed or will fail.

Some aspects of the present disclosure address some or all of the issues noted above, among others, by determining whether a failure condition is met when a merge train is executed. Systems disclosed herein may identify the failure condition by comparing log data from a failed job with a string associated with the failure condition. Determining whether the failure condition is met may rely on the type of failure. The type of failure corresponds to performance of a job included in the merge request. When merging updates to the main branch, there may be a series of jobs to test the updates before merging the updates with the main branch. When a job fails, systems described herein may provide failure information indicating warnings and errors regarding the failed job. The failure information may include text-based log data including textual information about the failure (for example, runtime error, segmentation faults, etc.). There may be types of failures that are critical and some that are non-critical. To identify the type of failure, the systems described herein can compare the text from failure information with strings associated with the failure condition. The failure condition is met when a match is found between the log data and the known critical failures. Otherwise, the failure condition is not met.

Additional aspects of the present disclosure relate to retrying a failed job or removing a merge request that includes the failed job in response to whether the failure condition is met. When the failure condition is met (a match between the failure information and the string), the systems described herein instruct the merge train to retry the failed job at least one more time. In this way, the system may determine the failure is tolerable to the merge train and provides another opportunity to run. When the failure condition is not met (there is no match between the failure information and the string or the failed job already failed before), the systems may update the merge train to remove the merge request that includes the failed job even if other jobs of the merge request have yet to be run. In this way, the systems update the merge train to link a prior merge request with respect to the merge request that includes the failed job to a subsequent merge request. The removal of the merge request allows for the merge train to continue without the merge request that includes the failed job. Thus, the system may provide efficient use of computational resources by retrying the failed job or removing the merge request that includes the failed job according to a type of failure, thereby freeing computational resources for use in executing other merge requests.

Various aspects of the disclosure will now be described with regard to certain examples and embodiments, which are intended to illustrate but not limit the disclosure. Although aspects of some embodiments described in the disclosure will focus, for the purpose of illustration, on particular examples of merging branches of software code, retrying failed jobs of a merge request, and removing merge requests, the examples are illustrative only and are not intended to be limiting. In some embodiments, the techniques described herein may be applied to additional or alternative computing environments, computing resources, processing units, and the like. Additionally, any feature used in any embodiment described herein may be used in any combination with any other feature or in any other embodiment, without limitation.

### Example Integration and Deployment Environments

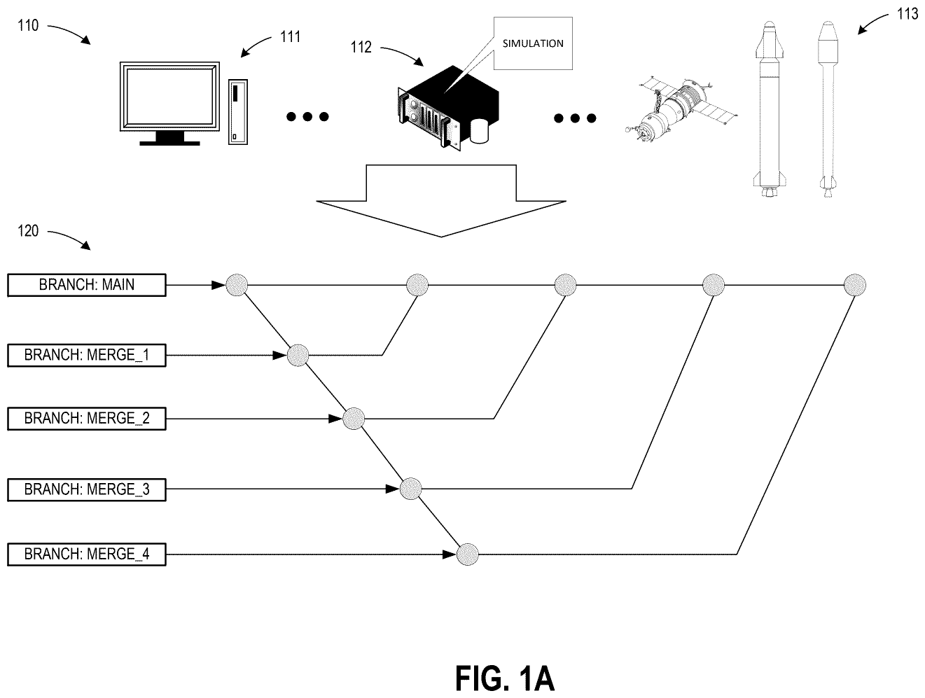

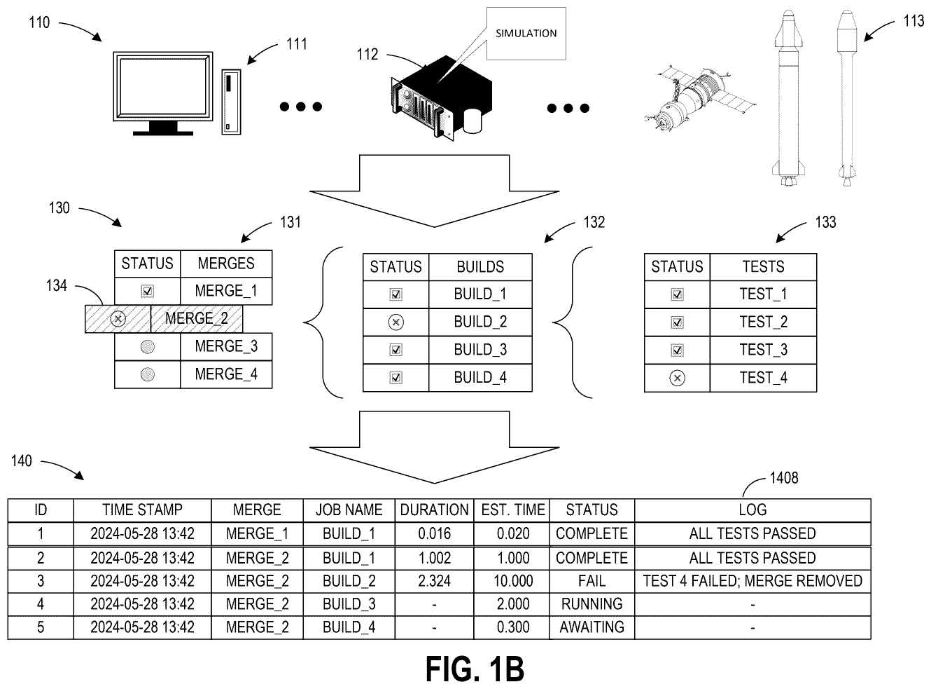

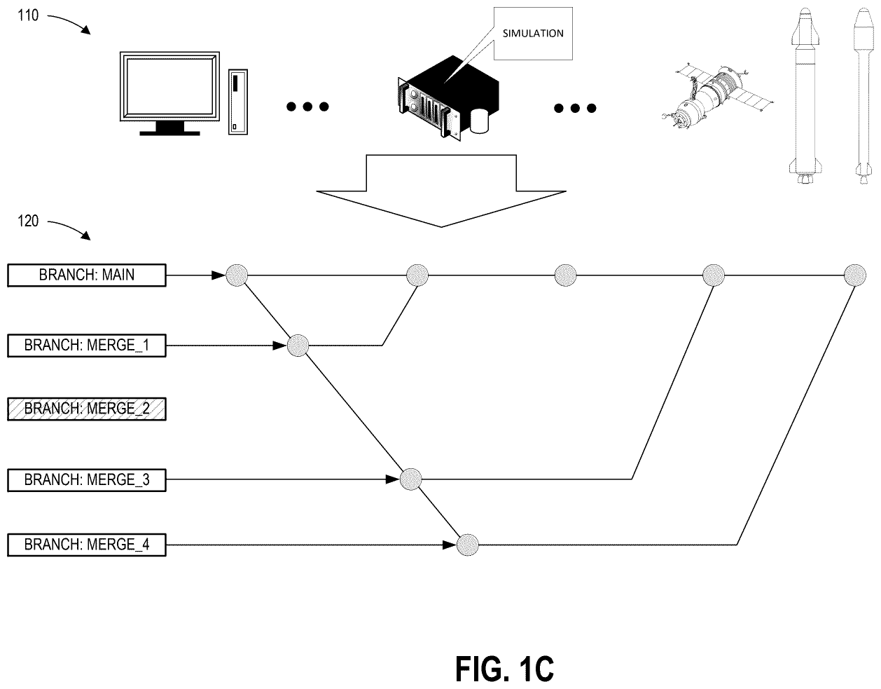

Conventional merge trains may lead to inefficiencies when merge requests fail due to merge trains running the remaining queued merge requests to completion and an inability to check conditions of the failure before removing the merge request that includes the failed job. In general, conventional merge trains introduce a way to order a flow of updates to a target branch (usually a main branch). When development teams provide many changes to the target branch, this can cause a situation where during the time to validate merged code for one change, another change has been merged to the main branch, invalidating the previous merged result. By using the conventional merge train, each merge request joins as the last item in that train with each merge request being processed in order. However, instead of queuing and waiting, each item takes the completed state of the previous (pending) merge reference (the merge result of the merge), adds changes, and starts a pipeline immediately in parallel under the assumption that everything is going to pass. If all pipelines in the conventional merge train are completed successfully, then no pipeline time is wasted on queuing or retrying. Pipelines invalidated through failures are canceled, the merge request causing the failure is removed, and the rest of the merge requests in the train are requeued without the need for manual intervention. However, when the code found in the merge request includes design simulations, running the remaining merge requests to completion may restrict computational resources for hours due to a reliance of the remaining merge requests on the failed design simulation. FIGS. 1A, 1B, and 1C depict an example continuous integration and continuous deployment environment integrating a merge train including a merge request for a design simulation of hardware systems.

FIG. 1A illustrates an example conventional merge train in a continuous integration and continuous deployment environment. As shown, a merge train 120 provides for queuing merge requests, which may include updates with design simulations. The main branch, in this manner, includes finalized source code that, when executed, run design simulations of various hardware (such as satellites, rockets, and corresponding subsystems). The design simulation workflow 110 may include development from user devices 111, testing the simulation with testing hardware 112, and simulated hardware systems 113. For example, the design simulations may include Monte Carlo simulations of spacecraft trajectories and parameters along the trajectories (such as mass, thrust, etc.). The merge branches (for example, MERGE_1, MERGE_2, MERGE_3, and MERGE_4) may include updates to the design simulations and corresponding support software, for example, global functions and variables. The merge train receives the merge requests as a queue (in order of requests received), tests updates from the merge requests, and merges the merge requests with the main branch. The merge train performs testing of the merge requests in parallel, such that each of the merge requests is tested with preceding merge request code. For example, as shown: code for Merge_1 is tested; code for Merge_1 and Merge_2 are tested together; code for Merge_1, Merge_2, and Merge_3 are tested together; and code for Merge_1, Merge_2, Merge_3, and Merge_4 are tested together. The merge train tests the merge requests in parallel according to the order in the queue. However, conventional merge trains perform tests on the remaining merge requests to completion regardless of reliance on the removed merge request. In this way, the merge request may fail several seconds into the tests, but may restrict computational resources for hours to complete testing of the remaining merge requests. Thus, running the remaining merge requests to completion wastes time for the engineers and computational resources that may otherwise be used for productive tasks.

FIG. 1B illustrates an example workflow for a merge train. The merge train may seek to perform testing of the merge request according to a plurality of queues 130. The plurality of queues 130 may include a merge queue 131, a build queue 132, and a test queue 133. The merge queue 131 may include a series of merge requests corresponding to a series of builds (as depicted in the build queue 132) to test the merge request (as depicted in the test queue 133). Each of the builds corresponds with a plurality of tests. Testing the merge requests allows for an assessment of the updates associated with the merge requests prior to merging the updates with the main branch. Otherwise, the main branch would be at risk of breaking from unverified testing of the updates. When a test fails, the merge train continues testing the remaining merge requests until completion. The merge train provides failure information 140 associated with the failed job. The failure information 140 includes log data such as time stamp, merge identifier, job name, duration of running the merge request, estimated time to run the merge request, status, and log. As shown in log 1408 of ID 3 of the failure information 140, TEST_4 failed. The merge train then removes a merge request 134 associated with the failed test from the merge train (as shown by the removal of the merge request 134 from the merge queue 131). Testing the remaining merge requests until completion of the merge train restricts computational resources from being used for productive tasks until the testing completes, at which point users may identify the failure, fix the issues with the failed merge, and re-run the entire merge train.

FIG. 1C illustrates the example diagram of the merge train after removing the merge request that includes the failed job. In this example, the merge train 120 restarts at the point that the merge request (MERGE_2) fails and attempts to run without the contents of MERGE_2. In this way, MERGE_2 will remain open in a failed state, so that a user can update and fix the failure before attempting to merge again.

### Example Integration and Deployment System and Data Flow

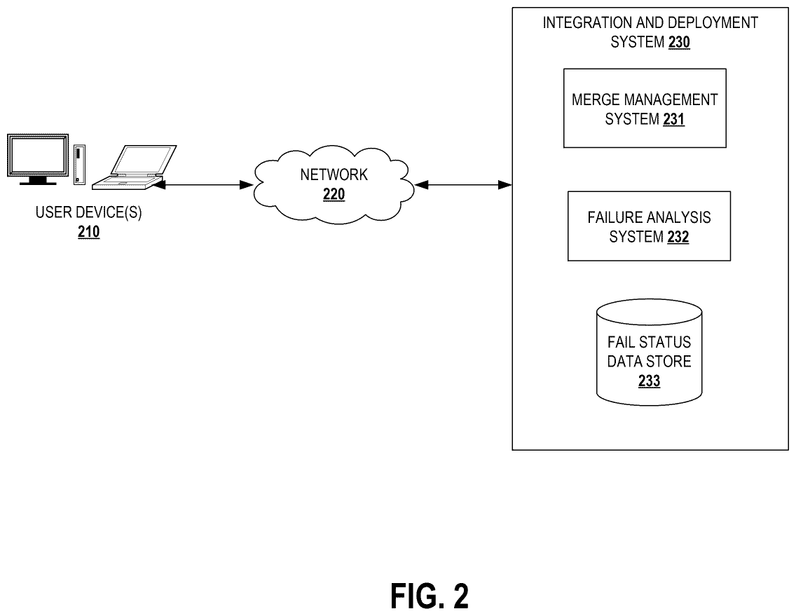

FIG. 2 illustrates an example development environment in which aspects of the present disclosure may be implemented. In some examples, as shown, the development environment may include any number of user devices 210, a network 220, and an integration and deployment system 230. The network enables communication between the user devices 210 and the integration and deployment system 230.

The user devices 210 may include various types of systems which may interact with the integration and deployment system 230 to manage merge requests. For example, the user devices 210 may include personal computing devices (such as desktops, laptops, and mobile communication devices).

The network 220 may be a publicly-accessible network of linked networks, possibly operated by various distinct parties, such as the Internet. In some cases, the network 220 may be or include a private network, personal area network, local area network, wide area network, global area network, cable network, satellite network, cellular data network, etc., or a combination thereof, some or all of which may or may not have access to and/or from the Internet. Although FIG. 2 illustrates a single network 220, the illustration is provided for purposes of example only, and is not intended to be limiting, required, or exhaustive. In some embodiments, the network 220 may include, or be in communication with, a plurality of networks. For example, the network 220 may include an internal network and a backbone network.

The integration and deployment system 230 may manage merge requests and merge trains to provide continuous integration and deployment for software applications. The integration and deployment system 230 may include several sub-components that operate to manage queuing, testing, and/or merge requests. The sub-components may include a merge management system 231, a failure analysis system 232, and a fail status data store 233.

In some examples, the merge management system 231 may manage merge requests and merge trains. In some examples, the merge management system 231 may receive merge requests from the user devices 210. The merge requests may include updates to versions of source code (such as code maintained in a main branch). The merge management system 231 may process the merge requests and generate a merge train according to a queue of the merge requests. For example, the merge management system 231 may schedule the merge requests for testing according to the queue. The merge management system 231 may test updates associated with the merge requests. In this way, the merge management system 231 may identify whether the merge request may harm the main branch when integrated. For example, the harm to the main branch may cause the main branch to encounter runtime errors, change functionality of the code in unintended ways, create vulnerabilities in code of the main branch, among other issues with the main branch. The merge management system 231 may identify an outcome of testing the merge requests. In some examples, the merge management system 231 may identify failures (and successes) of the merge requests. For example, the merge management system 231 may identify failures of the merge requests according to testing the merge requests with various jobs (may also be referred to herein as “builds” or “tests”) and assessing an output. In some cases, the merge management system 231 may adjust a status flag of the merge request from pending to running and from running to failed when a failure occurs. In this way, the merge management system 231 may pause the tests associated with the merge request.

In some examples, the merge management system 231 may identify an order of the merge train to reduce resource cost of the merge train. The merge management system 231 may obtain the merge requests according to when the merge management system 231 receives the request. In this way, the merge train may be a queue with the order being order of acquisition. The merge management system 231 may estimate merge train parameters with respect to each of the merge requests in the queue. For example, the merge management system 231 may estimate characteristics about each of the merge requests to obtain the merge train parameters. The characteristics may include an estimated time to complete a merge, a user identifier, a business unit, a priority status, or any other characteristic used to assess order of the merge train. In this way, the merge management system 231 may review the merge train parameters and reorder the merge train according to the merge train parameters. The merge management system 231 may assign a score to the merge requests according to the merge train parameters. For example, the score may correspond to a temporal parameter, resource cost parameter, priority parameter, or another parameter associated with reordering the merge train. In this way, the score corresponding to the temporal parameter may result in an order of the merge train that assigns a merge request with a smallest estimated duration as the first merge request and a merge request with a largest estimated duration as the last merge request.

In some examples, the merge management system 231 may provide failure information associated with a failed job. For example, the failure information may include log data with respect to the failure. The log data may include information identifying errors, such as textual data indicating segmentation faults, communication network failures, merge management errors, code errors, among other errors causing failures. The merge management system 231 may communicate the failed job and/or failure information to the failure analysis system 232. For example, the merge management system 231 may send the failure information to the failure analysis system 232.

In some examples, the failure analysis system 232 may assess failures of merge requests scheduled in the merge train. For example, the failure analysis system 232 may receive the failure information from the merge management system 231 to assess the failures. The failure analysis system 232 may determine whether the failure meets a condition (may also be referred to herein as “failure condition”). For example, the failure analysis system 232 may compare the failure information to a string associated with the condition to determine whether the failure information satisfies the condition. In some examples, comparing the log data from the failure information with the string associated with the condition includes determining a match to the string associated with the condition. The failure analysis system 232 may identify the match when at least part of the log data includes information associated with one or more of the following: a docker error, a connection error, a virtual central processing unit (CPU) error, volume limit error, insufficient free address error, segmentation error, library error, license error, and a duration error, and/or another type of failure cause associated with the failed job. For example, the failure analysis system 232 determines the condition is met when the failure information includes textual information with contents such as: “Is the docker daemon running?,” “remote: GitLab is not responding,” “Code: \\‘VcpuLimitExceeded\\’,” “Code: \\‘VolumeLimiteExceeded\\’,” “Code: \\‘RequestLimitExceeded\\’,” “error: RPC failed; HTTP 400 curl 55 The requested URL returned error: 400,” “InsufficientFreeAddressesInSubnet,” “Segmentation violation detected,” “lliibb__,” “License checkout failed.” In some examples, the failure analysis system 232 may determine the condition is met when a duration of a job passes a threshold. For example, the threshold may be 5 minutes. In some examples, the threshold may be between values, such as between approximately 0 minutes and 10 minutes, such as between approximately 1 minutes and 9 minutes, between approximately 2 minutes and 8 minutes, between approximately 3 minutes and 7 minutes, between approximately 6 minutes and 4 minutes, between approximately 5 minutes and 5 minutes, although values or ranges outside these values or ranges can be used in some cases.

In some examples, the failure analysis system 232 may instruct the merge management system 231 to resume merging the merge requests according to the condition. For example, in some cases, the failure analysis system 232 may instruct the merge management system 231 to retry a failed job when the condition is met. In some cases, the failure analysis system 232 may instruct the merge management system 231 to remove the failed merge from the merge train when the condition is not met.

In response to a determination that the failure information satisfies the condition, the failure analysis system 232 may retry the failed job. For example, the condition is met due to the failure information matching one or more of the strings of the condition. In some cases, the failure analysis system 232 may cause the merge management system 231 to retry the failed job. In this way, the failure information may indicate the failure is non-critical. The failed job may occur in response to network connection errors, or other aspects independent from the update associated with the failed job. In this way, retrying the failed job may provide for an efficient use of computational resources as compared to removing the failed merge request from the merge train and continuing the remaining merge requests. For example, removing the failed merge in the scenario of a non-critical job failing, the entire merge train would be updated and the merge request would be requeued at the end of the merge train. In this way, if the failed job were part of an instrumental merge for subsequent merge requests (such as a design simulation for hardware systems), the entire merge train may provide nominal value upon completion and would have to re-run regardless of whether the merge had issues causing the failed job. In some cases, the failed job may occur due to network conditions rather than errors in code of the merge request.

In response to a determination that the failure information does not satisfy the condition, the failure analysis system 232 may adjust the merge train. For example, the condition is not met due to the failure information not matching one or more of the strings of the condition. The failure analysis system 232 may cause the merge management system 231 to cease execution of the merge request that includes the failed job even if other jobs of the merge request have yet to be run. For example, the failure analysis system 232 may update the merge train to remove the merge request. In this way, the failure analysis system 232 may update the merge train from executing jobs associated with the merge request to execute jobs corresponding to preceding merge requests and subsequent merge requests. In this way, the failure analysis system 232 may cause execution of the updated merge train.

In some examples, the failure analysis system 232 may perform predictive failure detection. For example, predictive failure detection may include the failure analysis system 232 training a machine learning model to identify merge requests likely to cause a failure in the merge train. In some cases, data used to train the machine learning model may include collected data and/or synthetic data as disclosed herein. For example, the data may be collected and/or synthetic data including one or more of the following: user identifiers, time stamps (including time stamps of requested merges), merge identifier (such as specifying project, division, working group, etc.), log data, status indicators, and/or other types of features related to training a machine learning model as disclosed herein. The failure analysis system 232 may predict a failure according to failure characteristics. The failure characteristics may include various factors weighed together to determine whether a failure is likely. For example, the failure characteristics may include one or more of the following: a pattern of repetitive failures, a particular individual submitting a merge request, a project in which merge requests are submitted, a time of day, a network connection level, or another factor indicative of failure. The machine learning model may include a machine learning and/or artificial intelligence model. For example, the machine learning model may include supervised machine learning model or an unsupervised machine learning model. The machine learning model may include a logistic regression model, recurrent neural network (RNN), support vector machine (SVM), twin SVM (TWSVM), Gaussian mixture models, random forests, an artificial neural networks (ANN), an convolutional neural network (CNN), a deep neural network (DNN), a generative adversarial network (GAN), and/or generative models, such as a large language model (LLM), and/or transformers (such as generative pretrained transformers (GPT) and not pretrained transformers), or another form of machine learning model applicable herein. In this way, the failure analysis system 232 may predict a failure may occur and/or how likely a merge request might fail.

In some examples, the failure analysis system may apply root cause detection to a failed job. The failure analysis system 232 may identify aspects of the merge request causing the failure. For example, the failure analysis system 232 may identify whether the failure is associated with a system from which the merge request originated or updates associated with the merge request. In some examples, the failure analysis system 232 may identify the updates, such as changes found within code of the merge request, to be the root cause. In some cases, the failure analysis system 232 may provide suggestions to resolve the failure.

In some examples, the fail status data store 233 may store information regarding failures of the merge train. In some examples, the fail status data store 233 may store failure information associated with the failed job. In some examples, the fail status data store 233 may store strings associated with the condition. For example, the failure analysis system 232 may interact with the fail status data store 233 to obtain the string with which the failure analysis system 232 compares the failure information. In some examples, the fail status data store 233 may notify user devices of the failed job. For example, the fail status data store 233 may send a notification to the user devices 210 associated with the merge request that includes the failed job. In some cases, the notification information may include at least one or more of an identifier, time stamp, merge identifier, duration of run, estimated time to complete, status, and log, and other information with respect to tracking failures of merge requests.

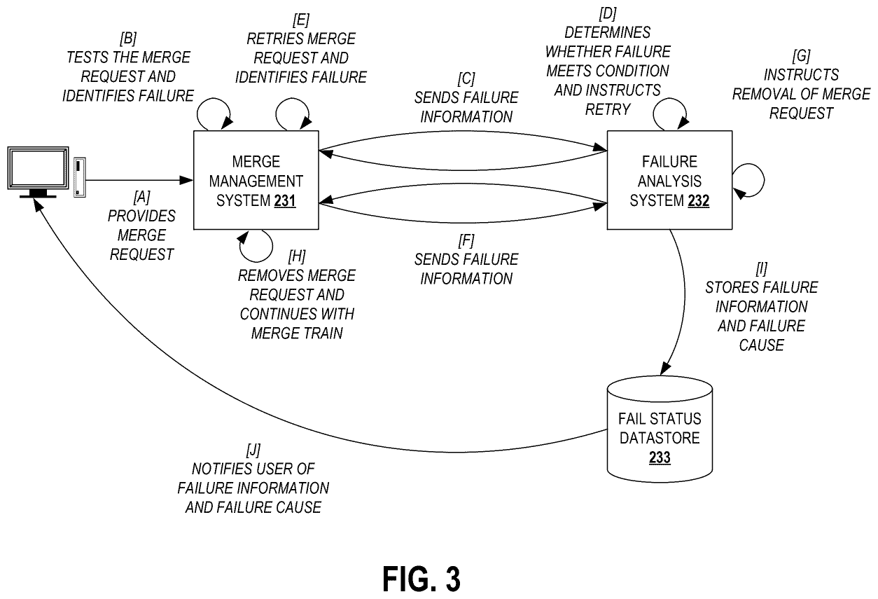

FIG. 3 is a diagram of illustrative data flows and interactions between a user device 210 and an integration and deployment system 230 by way of a merge management system 231, a failure analysis system 232, and a fail status data store 233 to perform efficient merge management of merge requests.

At [A], the user device 210 provides a merge request to the merge management system 231. In some examples, the merge management system 231 may receive the merge request via a user interface. For example, the user interface may be an interactive user interface, such as a graphical user interface. In some examples, the merge management system 231 may generate a merge train. The merge train may include a queue of merge requests. The merge management system 231 may process the merge requests and generate a merge train according to the queue of the merge requests. For example, the merge management system 231 may schedule the merge requests for testing according to the queue.

At [B], the merge management system 231 tests the merge request and identifies failure. The merge management system 231 may test a plurality of merge requests of the merge train. In some examples, the merge management system 231 tests updates associated with the merge requests by causing each of the merge requests to perform jobs. The result of the jobs may correspond to success or failure of the tested merge request. For example, the jobs may include a series of base functions for which the updates associated with the merge request may perform the functions and provide the merge management system 231 an output. The merge management system 231 may perform testing of the merge requests in parallel. In this way, the merge management system 231 may test each of the merge requests with preceding merge request code according to an order of the merge train. The order of the merge train may correspond to a queue as described herein.

The merge management system 231 may identify a failure of the merge request according to results of the tests as disclosed herein. For example, when the output of one or more of the tests is different than the expected output, the merge management system 231 may determine the merge request has failed. The merge management system 231 may generate failure information in response to the merge request failing. For example, the failure information may include log data associated with information of the failed job. In some cases, the log data may include textual information. The log data may include information as disclosed herein. For example, an identifier, time stamp, merge identifier, duration of run, estimated time to complete, status, and log, and other information with respect to tracking failures of merge requests. At [C], the merge management system 231 sends failure information to the failure analysis system 232.

At [D], the failure analysis system 232 determines whether the failure information meets a condition and instructs the merge management system 231 according to the condition. The failure analysis system 232 may compare the failure information to a string associated with the condition to determine whether the failure information satisfies the condition, as disclosed herein. For example, comparing the log data from the failure information with the string associated with the condition includes determining a match to the string associated with the condition. The failure analysis system 232 may identify the match when at least part of the log data includes information associated with one or more of the following: a docker error, a connection error, a virtual CPU error, volume limit error, insufficient free address error, segmentation error, library error, license error, and a duration error, and/or another type of failure cause associated with the failed job. In some examples, the failure analysis system 232 may determine the condition is met when a duration of a job passes a threshold, as disclosed herein.

The failure analysis system 232, in response to determining whether the condition is met, may instruct the merge management system 231 to either retry a failed job or remove the merge request that includes the failed job. As shown in FIG. 3, in response to a determination that the failure information does not satisfy the condition, the failure analysis system 232 may retry the failed job, as disclosed herein. For example, the condition is met due to the failure information matching one or more of the strings of the condition. In some cases, the failure analysis system 232 may cause the merge management system 231 to retry the failed job. In this way, the failure information may indicate the failure is non-critical. The failed job may occur in response to network connection errors, or other aspects independent from the update associated with the failed job. In this way, retrying the failed job may provide for an efficient use of computational resources as compared to removing the merge request from the merge train. For example, removing the failed merge in the scenario of the failure of a non-critical job, the entire merge train would be updated and the merge request that includes the failed job would have to be included at the end of the queue for the merge train. In this way, if the merge request were an instrumental merge for subsequent merge requests (such as a design simulation for hardware systems), the entire merge train may provide nominal value upon completion and would have to re-run with a fixed merge request.

In some cases (not as shown), and in response to a determination that the failure information does not satisfy the condition, the failure analysis system 232 may adjust the merge train. For example, the condition is not met if the failure information does not match one or more of the strings of the condition. The failure analysis system 232 may cause the merge management system 231 to cease execution of the merge request if the condition is not satisfied. For example, the failure analysis system 232 may update the merge train to remove the merge request that includes the failed job if the condition is not satisfied. In this way, the failure analysis system 232 may update the merge train from executing jobs associated with the merge request to execute jobs corresponding to preceding merge requests and subsequent merge requests. In this way, the failure analysis system 232 may cause execution of the updated merge train.

In some cases, when determining whether the failure information meets the condition, the failure analysis system 232 may consider a status of a preceding merge request. For example, if a job of a merge request has failed, and the merge request is the first in the merge train, then this job is at fault and the failure analysis system 232 removes the merge request from the merge train. In some examples, if the merge request failed one or more jobs and a preceding merge request has a passed status for all jobs, then the merge request is at fault and the failure analysis system 232 removes the merge request from the merge train. In some examples, if the merge request failed one or more jobs and a preceding merge request has a running or failed status for a job, then the merge train continues.

At [E], the merge management system 231 retries the failed job, identifies another failure, and sends additional failure information to the failure analysis system 232. The merge management system 231 may retry the failed job and identifies a failure as indicated herein (for example, as disclosed in [B] in FIG. 3). At [F], the merge management system 231 sends failure information to the failure analysis system 232 (for example, as disclosed in [C] in FIG. 3).

At [G], the failure analysis system 232 instructs the merge management system 231 to remove the merge request that includes the failed job from the merge train. The failure analysis system 232 may instruct the merge management system 231 to update the merge train. For example, the failure analysis system 232 may instruct the merge management system 231 to reorder the queue associated with the merge train.

At [H], the merge management system 231 removes the merge request and continues with the updated merge train. For example, the merge management system 231 may reorder the queue associated with the merge train. For example, the merge management system 231 may update the merge train to remove the merge request. In this way, the merge management system 231 may update the merge train from executing jobs associated with the merge request to execute jobs corresponding to preceding merge requests and subsequent merge requests. In this way, the merge management system 231 may cause execution of the updated merge train.

At [I], the failure analysis system 232 sends failure information and failure cause to the fail status data store 233. In some examples, the fail status data store 233 may store failure information associated with the failed job. For example, the fail status data store 233 may store the failure information that the failure analysis system 232 assesses to determine whether the failure meets the condition. In some examples, the fail status data store 233 may store strings associated with the condition. For example, the failure analysis system 232 may interact with the fail status data store 233 to obtain the string with which the failure analysis system 232 compares the failure information.

At [J], the fail status data store 233 notifies the user devices 210 of the failure information and failure cause. In some examples, the fail status data store 233 may notify user devices of the failed job. For example, the fail status data store 233 may send a notification to the user devices 210 associated with the merge request that includes the failed job. In some cases, the notification information may include at least one or more of an identifier, time stamp, merge identifier, duration of run, estimated time to complete, status, and log, and other information with respect to tracking failures of merge requests.

### Example Merge Management Routine

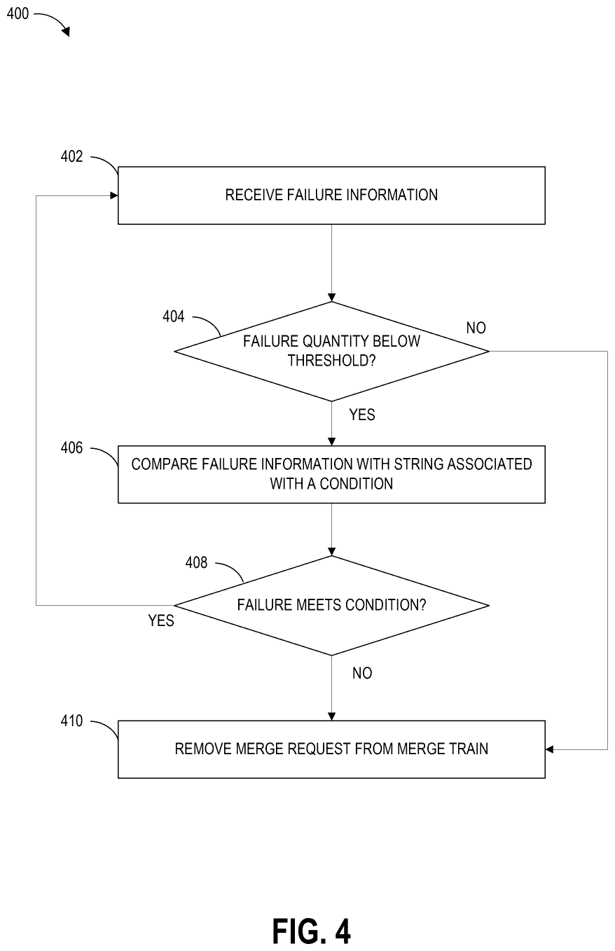

FIG. 4 is a flow diagram depicting an example merge management routine 400. The routine 400 may be carried out, for example, by an integration and deployment system 230 of FIG. 2. The routine 400 begins at block 402, where the integration and deployment system 230 receives failure information. For example, the failure information may include log data with respect to the failure of a job of a merge request. The log data may include information identifying errors, such as textual data indicating segmentation faults, communication network failures, merge management errors, code errors, among other errors causing failures.

At block 404, the integration and deployment system 230 determines whether a quantity corresponding to a number of times the job has failed is below a threshold. In some examples, the threshold may include 1 time, 2 times, 3 times, 4 times, 5, times, 6 times, 7 times, 8 times, 9 times, or 10 times, or another quantity associated with a number of times the merge request failed. If the quantity is below the threshold, the routine 400 continues with block 406. If the quantity is above the threshold, the routine 400 continues with block 410.

At block 406, the integration and deployment system 230 compares failure information from the failed job with at least one string associated with the condition. In some examples, comparing the log data from the failure information with the string associated with the condition includes determining a match to the string associated with the condition, as disclosed herein. For example, comparing log data from the failure information with the string associated with the condition includes determining a match to the string associated with the condition. The failure analysis system 232 may identify the match when at least part of the log data includes information associated with one or more of the following: a docker error, a connection error, a virtual CPU error, volume limit error, insufficient free address error, segmentation error, library error, license error, and a duration error, and/or another type of failure cause associated with the failed job. In some examples, the failure analysis system 232 may determine the condition is met when a duration of a job passes a threshold, as disclosed herein.

At block 408, the integration and deployment system 230 determines whether the failure meets the condition. In some examples, the condition is met due to the failure information matching one or more of the strings of the condition. In this way, the failure information may indicate the failure is non-critical. The failed job may occur in response to network connection errors, or other aspects independent from the update associated with the failed job. In response to a determination that the failure information satisfies the condition, the integration and deployment system 230 may retry the failed job. In this way, retrying the failed job may provide for an efficient use of computational resources as compared to removing the merge request from the merge train. In some examples, the condition is not met due to the failure information not matching one or more of the strings of the condition. In response to a determination that the failure information does not satisfy the condition, the integration and deployment system 230 may adjust the merge train. For example, the integration and deployment system 230 may cease execution of the merge request. In this way, the integration and deployment system 230 may cause execution of the updated merge train. If the failure meets the condition, the routine 400 continues to block 402. If the failure does not meet the condition, the routine 400 continues with block 410.

At block 410, the integration and deployment system 230 removes the merge request from the merge train. For example, the integration and deployment system 230 may update the merge train to skip the merge request that includes the failed job. In this way, the integration and deployment system 230 may requeue the merge train to execute a preceding merge request and a subsequent merge request.

### Example Computing Device

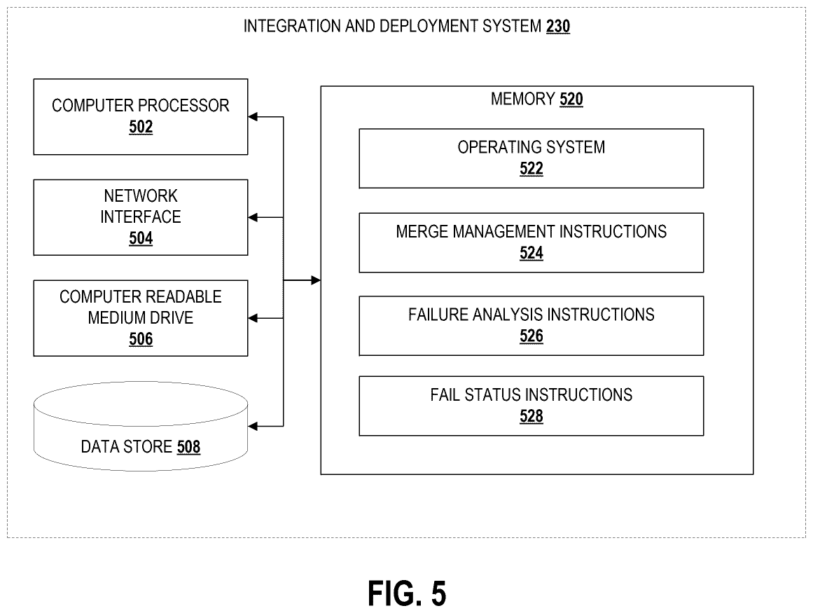

FIG. 5 illustrates various components of an example computing device configured to implement various functionality of the integration and deployment system 230. In some embodiments, as shown, the integration and deployment system 230 may include: one or more computer processors 502, such as physical central processing units (“CPUs”); one or more network interfaces 504, such as a network interface cards (“NICs”); one or more computer-readable medium drives 506, such as a high density disk (“HDDs”), solid state drives (“SSDs”), flash drives, and/or other persistent non-transitory computer-readable media; one or more data store 508, such as physical storage and/or remote storage, and/or other data storage components; and one or more computer-readable memories 520, such as random access memory (“RAM”) and/or other volatile non-transitory computer-readable media. The computer-readable memory 520 may include computer program instructions that one or more computer processors 502 execute in order to implement one or more embodiments. The computer-readable memory 520 can store an operating system 522 that provides computer program instructions for use by the computer processor(s) 502 in the general administration and operation of the integration and deployment system 230. In some embodiments, the computer-readable memory 520 can further include computer program instructions and other information for implementing aspects of the present disclosure. For example, the computer-readable memory 520 may include merge management instructions 524 for managing merge requests, as described herein. As another example, the computer-readable memory 520 may include failure analysis instructions 526 for analyzing failures of merge requests, as described herein. As another example, the computer-readable memory 520 may include fail status instructions 528 for managing fail status information, as described herein. When a routine is initiated, a corresponding set of executable program instructions stored on a computer-readable medium drive 506 may be loaded into computer-readable memory 520 and executed by one or more computer processors 502. In some embodiments, a routine—or portions thereof—may be implemented on multiple computing devices and/or multiple processors, serially or in parallel.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or logic circuitry that implements a state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements, or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or”means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system comprising:
a memory comprising computer-executable instructions; and
a processor, wherein the computer-executable instructions, when executed by the processor, cause the processor to:
receive a first merge request to merge a first version of source code and a second version of source, wherein the first merge request comprises a first plurality of jobs;
receive a second merge request to merge the first version, the second version, and a third version of source code, wherein the second merge request comprises a second plurality of jobs;
cause execution of the first plurality of jobs and the second plurality of jobs;
identify a failure of a first job in the first plurality of jobs, wherein the first job failing provides failure information;
cause execution of individual jobs in the first plurality of jobs and the second plurality of jobs to pause;
process the failure information associated with the first job failing;
compare log data from the failure information with a string associated with a condition to determine whether the failure information satisfies the condition;
in response to a determination that the failure information satisfies the condition, retry the failed first job; and
in response to a determination that the failure information does not satisfy the condition,
pause execution of the first plurality of jobs and the second plurality of jobs that have yet to be executed,
update the second merge request to include a merge of the first version of the source code, the third version of the source code, and not the second version of the source code, wherein the updated second merge request comprises a third plurality of jobs,
cause execution of the third plurality of jobs, and
remove the first merge request from a list of merge requests to be executed.

2. The system of claim 1, wherein the computer-executable instructions, when executed by the processor, further cause the processor to retry the failed job when the log data includes one or more of: a docker error, a connection error, a virtual central processing unit error, volume limit error, insufficient free address error, segmentation error, library error, license error, and a duration error.

3. The system of claim 1, wherein the condition is met when at least a part of the log data matches the string.

4. The system of claim 1, wherein the computer-executable instructions, when executed by the processor, further cause the processor to cause the execution of the updated second plurality of jobs prior to completion of a plurality of merge requests.

5. The system of claim 1, wherein the computer-executable instructions, when executed by the processor, further cause the processor to update the second plurality of jobs from executing individual jobs corresponding to the first, second, and third versions of the source code to execute individual jobs corresponding to the first version of the source code and the third version of the source code.

6. A computer implemented method comprising:
under control of a user device with a processor and memory, wherein computer-executable instructions, when executed by the processor, cause the user device to perform steps of:
receiving a first merge request to merge a first version of source code and a second version of source, wherein the first merge request comprises a first plurality of jobs;
receiving a second merge request to merge the first version, the second version, and a third version of source code, wherein the second merge request comprises a second plurality of jobs;
causing execution of the first plurality of jobs and the second plurality of jobs;
identifying a failure of a first job in the first plurality of jobs, wherein the first job failing provides failure information;
causing execution of individual jobs in the first plurality of jobs and the second plurality of jobs to pause;
processing the failure information associated with the first job failing;
comparing log data from the failure information with a string associated with a condition to determine whether the failure information satisfies the condition; and
in response to a determination that the failure information does not satisfy the condition,
pause execution of the first plurality of jobs and the second plurality of jobs that have yet to be executed,
update the second merge request to include a merge of the first version of the source code, the third version of the source code, and not the second version of the source code, wherein the updated second merge request comprises a third plurality of jobs,
cause execution of the third plurality of jobs, and
remove the first merge request from a list of merge requests to be executed.

7. The computer implemented method of claim 6, wherein the condition is not satisfied when at least a part of the log data matches the string, and wherein removing the first merge request from the list of merge requests comprises removing the first merge request when the log data does not include: a docker error, a connection error, a virtual central processing unit error, volume limit error, insufficient free address error, segmentation error, library error, license error, or a duration error.

8. The computer implemented method of claim 6, wherein causing the execution of the third plurality of jobs comprises causing the execution of the third plurality of jobs prior to completion of a plurality of merge requests.

9. The computer implemented method of claim 6, wherein at least one of the first version of source code, the second version of source code, and the third version of source code are directed to design simulation source code.

10. The computer implemented method of claim 6, wherein the first plurality of jobs is associated with merging the first version of source code and the second version of source code, and wherein the second plurality of jobs is associated with merging the first version of source code, the second version of source code, and the third version of source code.

11. The computer implemented method of claim 6, wherein removing the first merge request from the list of merge requests to be executed comprises:
removing the first merge request from the list of merge requests when the first merge request is at a beginning of the list of merge requests; and
removing the first merge request from the list of merge requests when a preceding merge request of a plurality of merge requests passed all of a plurality of jobs.

12. The computer implemented method of claim 6, wherein the condition is satisfied when at least a part of the log data matches the string, and wherein the method further comprises, in response to a determination that the failure information does satisfy the condition, retrying the failed first job.

13. The computer implemented method of claim 12, wherein retrying the failed first job comprises retrying the failed first job when the log data includes one or more of: a docker error, a connection error, a virtual central processing unit error, volume limit error, insufficient free address error, segmentation error, library error, license error, and a duration error.

14. The computer implemented method of claim 12, wherein retrying the failed first job comprises retrying the failed first job by maintaining execution order of the first version of source code, the second version of source code, and the third version of source code.

15. Non-transitory, computer-readable storage media comprising computer-executable instructions for managing a merge request queue in a merge train, wherein the computer-executable instructions, when executed by a computer system, cause the computer system to:
receive a first merge request to merge a first version of source code and a second version of source, wherein the first merge request comprises a first plurality of jobs;
receive a second merge request to merge the first version, the second version, and a third version of source code, wherein the second merge request comprises a second plurality of jobs;
cause execution of the first plurality of jobs and the second plurality of jobs;
identify a failure of a first job in the first plurality of jobs, wherein the first job failing provides failure information;
cause execution of individual jobs in the first plurality of jobs and the second plurality of jobs to pause;
process the failure information associated with the first job failing;
compare log data from the failure information with a string associated with a condition to determine whether the failure information satisfies the condition; and
in response to a determination that the failure information does not satisfy the condition,
pause execution of the first plurality of jobs and the second plurality of jobs that have yet to be executed,
update the second merge request to include a merge of the first version of the source code, the third version of the source code, and not the second version of the source code, wherein the updated second merge request comprises a third plurality of jobs,
cause execution of the third plurality of jobs, and
remove the first merge request from a list of merge requests to be executed.

16. The non-transitory, computer-readable storage media of claim 15, wherein the condition is not satisfied when at least a part of the log data matches the string, and wherein the computer-executable instructions further cause the computer system to:
remove the first merge request when the log data does not include: a docker error, a connection error, a virtual central processing unit error, volume limit error, insufficient free address error, segmentation error, library error, license error, or a duration error;
remove the first merge request from the list of merge requests when the first merge request is at a beginning of the list of merge requests; and
remove the first merge request from the list of merge requests when a preceding merge request of a plurality of merge requests passed all of a plurality of jobs.

17. The non-transitory, computer-readable storage media of claim 15, wherein the computer-executable instructions further cause the computer system to cause the execution of the third plurality of jobs prior to completion of a plurality of merge requests.

18. The non-transitory, computer-readable storage media of claim 15, wherein the condition is satisfied when at least a part of the log data matches the string, and wherein the computer-executable instructions further cause the computer system to, in response to a determination that the failure information does satisfy the condition, retry the failed first job.

19. The non-transitory, computer-readable storage media of claim 18, wherein the computer-executable instructions further cause the computer system to retry the failed first job when the log data includes one or more of: a docker error, a connection error, a virtual central processing unit error, volume limit error, insufficient free address error, segmentation error, library error, license error, and a duration error.

20. The non-transitory, computer-readable storage media of claim 18, wherein the computer-executable instructions further cause the computer system to retry the failed first job by maintaining execution order of the first version of source code, the second version of source code, and the third version of source code.
